(19) United States
(12) Patent Application Publication
(10) Pub. No.: US 2022/0347599 A1
(43) Pub. Date: Nov. 3, 2022

(54) MOISTURE REMOVAL DEVICE USING ROTATING DISK AND NITROGEN PEELING

(71) Applicant: Solge Corp., Daegu (KR)

(72) Inventor: Tae Heon Kim, Daegu (KR)

(21) Appl. No.: 17/622,193

(22) PCT Filed: Oct. 29, 2020
(86) PCT No.: PCT/KR2020/014870

§ 371 Date: Dec. 22, 2021

(30) Foreign Application Priority Data
Oct. 28, 2020 (KR) 10-2020-0141618

(51) Int. Cl. B01D 17/02; B01D 36/00; B01D 29/52

(52) U.S. Cl. CPC B01D 17/0205; B01D 36/006; B01D 29/52

(57) ABSTRACT

Proposed is a moisture removal device using a rotating disk and nitrogen peeling according to the present disclosure may include a circulation pump unit for circulating the oil in the storage tank connected to the circulation pump on one side of the device body via a valve, a chamber for exposing the oil circulated through the circulation pump unit into the chamber headspace through the rotation of the plurality of rotating disks, and a membrane unit that supplies dry nitrogen gas to oil exposed in the chamber headspace through rotation of a plurality of rotating disks of the chamber. The moisture removal device may remove free moisture, emulsified moisture, and dissolved moisture in oil contaminated with moisture through dry nitrogen gas purging by using a continuously rotating disk.

### TECHNICAL FIELD

The present disclosure relates to a moisture removal device using a rotating disk and nitrogen peeling. More specifically, the present disclosure relates to a moisture removal device using a rotating disk and nitrogen peeling, the device being capable of removing even free moisture, emulsified moisture, and dissolved moisture from contaminated oil through dry nitrogen gas purging by using a continuously rotating disk.

### BACKGROUND TECHNOLOGY

In general, lubricating oil is an oil used to reduce frictional force generated on the frictional surface of a machine or to disperse frictional heat generated on the frictional surface. Turbine oil used as such a lubricating oil is being used while circulating in industrial site facilities. At this time, air introduced into the facility systems of an industrial site contains many contaminants such as particles and moisture, and the contaminants cause fatal failure of the facility systems and rapidly shorten the lifespan of the lubricating oil. Therefore, it is most important to prevent the intrusion of contaminants into a facility system and to keep the lubricating oil clean by removing the internal moisture. A breather is used to perform this function.

However, the conventional breather is necessarily applied and used to prevent contamination of lubricating oil and remove moisture, which is a cause of equipment failure in industrial sites such as storage tanks and upper bearing housings. However, these breather products do not reflect the use environment of various industrial sites, do not meet the specialized standards required at industrial sites, waste money, and cause and environmental problems.

That is, in many industrial sites, a lot of money is spent every year to remove the negative effects of fluid contamination caused by moisture in the air, suspended particles, etc., and the contaminated lubricating oil and hydraulic oil causes excessive wear and failure of mechanical equipment. Currently, in domestic industrial sites, only oil replacement is applied to these fluid pollutants when oil life expires, and efforts to prevent contamination are insufficient, and equipment failures caused by already contaminated oil use incur high maintenance costs. This causes a huge loss in terms of productivity as well as profits.

In particular, a method for preventing oil contamination, which is a high cause of hydraulic equipment failure, is very important. The prevention of moisture that easily penetrates and contaminates oil among many contaminants has been highlighted. Currently, most breathers used in storage tanks in industrial sites are simply used as airflow paths and do not perform functions to prevent or remove contaminants, and using inappropriate breathers may further encourage the cause of contamination. In other words, there is an increasing demand for a breather capable of precision filtration in many device industries to prevent fluid contamination, which is the root cause of malfunctions of rotating machinery and hydraulic equipment, and to reduce failures in production facilities and improve facility operation reliability. The breather is an expensive imported product, so it is not easy to use. Since some of the components are all-in-one, the entire breather must be replaced at the end of its life, resulting in high maintenance costs and waste of environmental pollution and resources because existing all-in-one breathers must be discarded despite some functions degradation.

In particular, as a method of removing moisture in lubricating oil, there are typically a centrifugal method, a vacuum method, and a filter adsorption method, and the centrifugal method is most commonly used. In the case of the centrifugal method, there is a performance limit that can remove only free moisture in the lubricating oil, and in the case of the filter adsorption method, the filter must be replaced exhaustively. In addition, the vacuum method has a disadvantage in that the structure is complicated, and maintenance costs are high due to frequent failures.

### DISCLOSURE

### Technical Problem

The present disclosure is proposed to solve the above problems of the previously proposed methods. An objective of the present disclosure is to provide a moisture removal device using a rotating disk and nitrogen peeling, the device being capable of removing free moisture, emulsified moisture, and dissolved moisture from oil contaminated with moisture, using continuous rotation of a rotating disk and purging of dry nitrogen gas. The moisture removal device includes: a circulation pump unit for circulating the oil of the storage tank connected to circulation pump through a valve on one side of the device body; a chamber configured to cause the oil circulated and supplied by the circulation pump unit to be exposed in a chamber headspace through rotation of a plurality of rotating disks; and a membrane unit for supplying dry nitrogen gas to the oil exposed in the chamber headspace by being circulated and supplied through the rotation of the plurality of rotating disks of the chamber.

Another objective of the present disclosure is to propose a moisture removal device using a rotating disk and nitrogen peeling. The device is configured in the following manner: inactive and extremely dry nitrogen gas is generated and supplied to a disk tank of a chamber in which lubricating oil and the nitrogen gas are to be mixed; multiple rotating disks installed in multiple stages in the chamber rotate to maximize contact between the dry nitrogen gas and the lubricating oil; and the nitrogen gas comes to hold the moisture through nitrogen peeling and then exits the device so that the moisture can be removed from the lubricating oil. With this configuration, it is possible to lower the concentration of contaminant in the lubricating oil, thereby prolonging the replacement cycle of lubricating oil (i.e., purified oil) beyond the simple employment of existing breather devices, increasing the management efficiency of the oil purification, and reducing the cost.

### Technical Solution

The moisture removal device using a rotating disk and nitrogen peeling that are the features of the present disclosure,

is a moisture removal device using a rotating disk and nitrogen peeling for achieving the above objective. The present disclosure is configured to include:

a circulation pump unit for circulating oil in of the storage tank connected to circulation pump to one side of the device body via a valve;

a chamber configured to cause the oil circulated by the circulation pump unit to be exposed in a chamber headspace through rotation of a plurality of rotating disks; and

a membrane unit configured to supply dry nitrogen gas to the oil exposed in the chamber headspace through rotation of the plurality of rotating disks of the chamber.

Preferably, the circulation pump unit may further include:

an inlet pump configured to supply the oil of the storage tank to the chamber; and

an outlet pump for discharging the resulting moisture-free oil from the chamber to the storage tank.

More preferably, the circulation pump unit may further include:

a pair of particle filters configured to remove particles contained in circulating oil, in which one of the pair of the particle filters is connected between the inlet pump and the chamber and the other is connected between the outlet pump and the chamber.

Preferably, the chamber may include:

a disk tank in which a plurality of rotating disks for purifying the oil circulated and supplied by the circulation pump unit is installed;

a return tank connected to a lower portion of the disk tank and configured to circulate the moisture-free oil from the disk tank to the storage tank through operation of the circulation pump unit; and

a driving unit for rotationally driving the plurality of rotating disks installed in the disk tank.

More preferably, the driving unit may include:

a small geared motor configured to rotate the plurality of rotating disks installed in the disk tank; a power transmission unit connected with a combination of a reducer and a pulley; and a driving shaft.

More preferably, each of the plurality of rotating disks

may have a disk shape and may have a check plate structure, in which a hole for fastening a driving shaft is formed at a center in a disk shape and a protrusion is formed in a radial disk of the hole.

Even more preferably, the plurality of rotating disks

may increase a contact area between the oil supplied to the disk tank and air by causing the oil to be exposed in the chamber headspace by the rotation thereof.

More preferably, the membrane unit may include:

a nitrogen generator for supplying dry nitrogen gas to the oil supplied to be exposed in the chamber headspace through the rotation of the plurality of rotating disks of the chamber; and

a slit nozzle through which nitrogen uniformly flows and is supplied to a plurality of rotating disks installed in the disk chamber in which the oil and the nitrogen gas are mixed while the nitrogen gas generated by the nitrogen generator is supplied to the disk chamber of the chamber.

### Advantageous Effects

According to the present disclosure, the moisture removal device using the nitrogen peeling and the rotating disks is configured to include: a circulation pump unit for circulating the oil of the oil of the storage tank connected to circulation pump through a valve on one side of the device body; a chamber exposing oil circulating and supplied through the circulation pump unit to the chamber headspace through rotation of a plurality of rotating disks; and a membrane unit for supplying dry nitrogen gas to the oil exposed into the chamber headspace through the rotation of the plurality of rotating disks of the chamber, so that free moisture, emulsified, and dissolved moisture in the oil contaminated with moisture may be removed through dry nitrogen gas purging by using a continuously rotating disk.

In addition, according to the moisture removal device using the nitrogen peeling and rotating disks of the present disclosure, the moisture removal device is configured such that nitrogen supplied by nitrogen peeling holds moisture in the lubricating oil and discharges the moisture to the outside to remove moisture in the lubricating oil, in which inactive and very dry nitrogen is generated to supply nitrogen to the disk tank of the chamber where the lubricating oil and nitrogen are mixed, and the rotating disk installed in multiple stages inside the chamber rotates to maximize the contact surface area between the dry nitrogen and the lubricating oil. The moisture removal device may extend the replacement cycles of refined oil in which the degree of contamination of moisture is lowered beyond the simple employment of existing breather devices, thereby increasing the management efficiency of the oil purification and reducing the cost.

### DESCRIPTION OF DRAWINGS

FIG. 1 is a functional block diagram illustrating a moisture removal device using a rotating disk and nitrogen peeling, according to one embodiment of the present disclosure;

FIG. 2 is a view showing the configuration of functional blocks of the circulation pump unit of the moisture removal device using a rotating disk and nitrogen peeling, according to an embodiment of the present disclosure;

FIG. 3 is a view showing the configuration of the chamber of the moisture removal device using a rotating disk and nitrogen peeling according to an embodiment of the present disclosure as a functional block;

FIG. 4 is a view showing the configuration of a membrane unit of a moisture removal device using a rotating disk and nitrogen peeling according to an embodiment of the present disclosure as a functional block;

FIG. 5 is a perspective view showing a configuration of a moisture removal device using a rotating disk and nitrogen peeling according to an embodiment of the present disclosure;

FIG. 6 is a view schematically showing the internal configuration of a moisture removal device using a rotating disk and nitrogen peeling according to an embodiment of the present disclosure;

FIG. 7 is a view schematically showing a connection configuration between the internal configuration of the moisture removal device using a rotating disk and nitrogen peeling according to an embodiment of the present disclosure;

FIG. 8 is a view showing the configuration of the rotating disk of the moisture removal device using a rotating disk and nitrogen peeling according to an embodiment of the present disclosure; and

FIG. 9 is a view schematically showing the operation process of the moisture removal device using a rotating disk and nitrogen peeling according to an embodiment of the present disclosure.

### DESCRIPTION OF SYMBOLS

100: Moisture removal device according to an embodiment of the present disclosure

101: Device body

110: Circulation pump unit

111: Inlet pump

112: Outlet pump

113: A pair of particle filters

120: Chamber

121: Rotating disk

122: Disk tank

123: Return tank

124: Driving unit

130: Membrane unit

131: Nitrogen generator

132: Slit nozzle

### BEST MODE

Hereinafter, with reference to the accompanying drawings, preferred embodiments will be described in detail so that those of ordinary skilled in the art to which the present disclosure pertains can easily practice the present disclosure. However, in describing a preferred embodiment of the present disclosure in detail, if it is determined that a detailed description of a related known function or configuration may unnecessarily obscure the gist of the present disclosure, the detailed description thereof will be omitted. In addition, the same reference numerals are used throughout the drawings for parts having similar functions and functions.

In addition, throughout the specification, when a part is “directly connected” to another part, it includes not only a case where a part is “directly connected” but also a case where another device is “indirectly connected” with another device interposed therebetween. In addition, “including” a certain component means that other components may be further included, rather than excluding other components, unless specifically stated to the contrary.

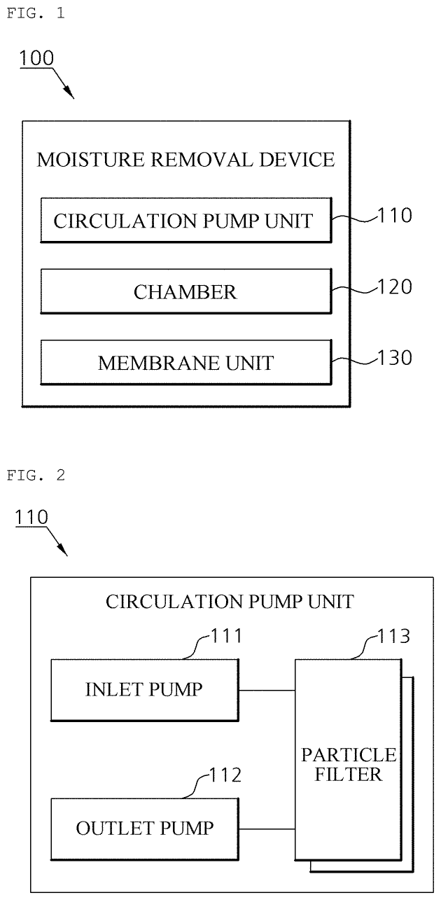

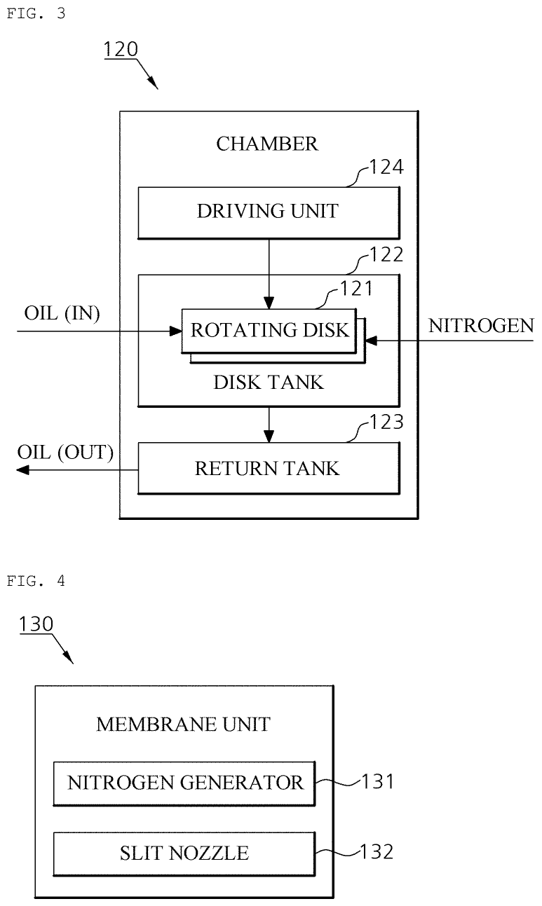

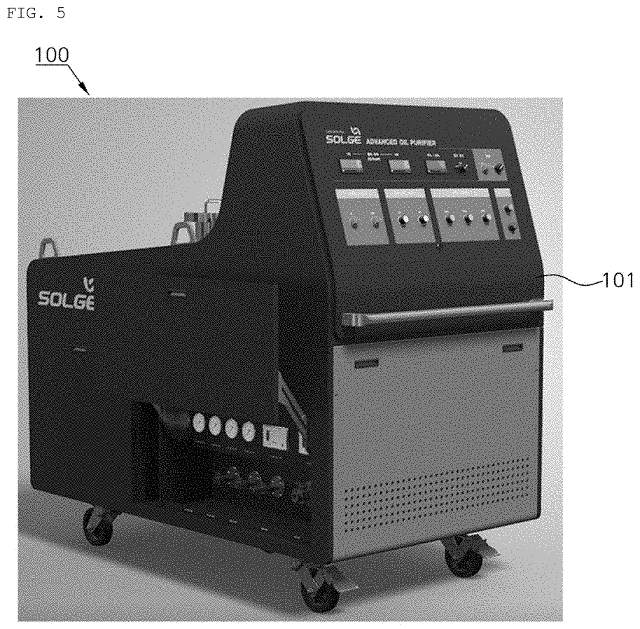

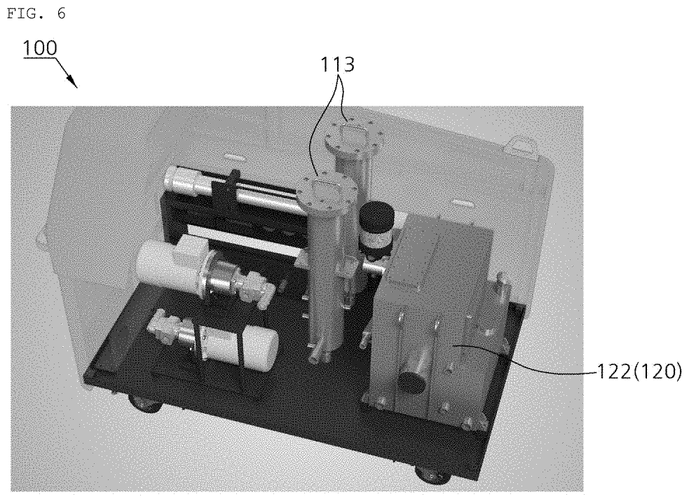

FIG. 1 is a view showing the configuration of a moisture removal device using a rotating disk and nitrogen peeling according to an embodiment of the present disclosure as a functional block, FIG. 2 is a view showing a configuration of a circulation pump unit of a moisture removal device using a rotating disk and nitrogen peeling according to an embodiment of the present disclosure as a functional block, FIG. 3 is a view showing a configuration of a chamber of a moisture removal device using a rotating disk and nitrogen peeling according to an embodiment of the present disclosure as a functional block, and FIG. 4 is a view showing a configuration of a membrane unit of a moisture removal device using a rotating disk and nitrogen peeling according to an embodiment of the present disclosure as a functional block. According to an embodiment of the present disclosure, referring to FIGS. 1 to 4, the moisture removal device 100 using a rotating disk and nitrogen peeling includes a circulation pump unit 110, a chamber 120, and a membrane unit 130.

The circulation pump unit 110 is configured to circulate an oil in the storage tank connected to the circulation pump through a valve on one side of the device body 101. As shown in FIG. 2, the circulation pump unit 110 may include an inlet pump 111 for supplying oil from the storage tank to a chamber 120 to be described later and an outlet pump 112 for discharging oil from the chamber 120 to the storage tank. Here, the circulation pump unit 110 serves to circulate the oil stored in the storage tank, that is, turbine oil, to a chamber 120, to be described later.

In addition, as shown in FIG. 2, the circulation pump unit 110 is connected and installed between the inlet pump 111 and the chamber 120, and between the outlet pump 112 and the chamber 120, respectively. A pair of particle filters 113 for removing particles contained in the oil may be further included. The circulation pump unit 110 circulates oil to the chamber 120 and may remove particles that may be included in the circulating oil before supplying the oil to the chamber 120 and before discharging the oil from the chamber 120 with the use of the pair of particle filters 113.

The chamber 120 is configured to expose the oil circulated and supplied through the circulation pump unit 110 into the chamber headspace through the rotation of the plurality of rotating disks 121. As shown in FIG. 3, the chamber 120 may include: a disk tank 122 in which a plurality of rotating disks 121 for purifying oil circulated and supplied through the circulation pump unit 110 are installed; the return tank 123 connected to the lower portion of the disk tank 122 and circulates the oil from which moisture has been removed from the disk tank 122 to the storage tank through the operation of the circulation pump unit 110; and a driving unit 124 for rotating and driving a plurality of rotating disks 121 installed inside the disk tank 122.

In addition, the driving unit 124 of the chamber 120 may include: a small geared motor capable of rotating a plurality of rotating disks 121 installed inside the disk tank 122; a power transmission unit connected to a combination of a reducer and a pulley; and a drive shaft. Here, the driving unit 123 may rotationally drive the plurality of rotation disks 121 installed in the disk tank 122 of the chamber 120.

In addition, the plurality of rotating disks 121 may be formed in a check plate structure in which a hole for fastening a driving shaft is formed at a center in a disk shape and a protrusion is formed in a radial disk of the hole. The plurality of rotating disks 121 may increase the contact area between oil and air by exposing the oil supplied to the disk tank 122 to the chamber headspace by rotation.

The membrane unit 130 is configured to supply dry nitrogen gas to oil exposed to the chamber headspace through rotation of the plurality of rotating disks 121 of the chamber 120. As shown in FIG. 4, the membrane unit 130 may include: a nitrogen generator 131 that supplies dry nitrogen gas to oil exposed to the chamber headspace through rotation of the plurality of rotating disks 121 of the chamber 120; and a slit nozzle through which nitrogen uniformly flows and is supplied to a plurality of rotating disks installed in the disk chamber where oil and nitrogen are mixed while supplying the nitrogen generated by the nitrogen generator to the disk chamber of the chamber.

In addition, the membrane unit 130 functions to remove moisture by supplying the dry nitrogen gas to the oil exposed to the chamber headspace by a plurality of rotating disks 201 that continuously rotate. At this time, the nitrogen gas purging serves to remove the moisture contained in the oil, thereby purifying the oil.

FIG. 5 is a view showing a perspective configuration of a moisture removal device using a rotating disk and nitrogen peeling according to an embodiment of the present disclosure. As shown in FIG. 5, in the moisture removal device 100 using a rotating disk and nitrogen peeling according to the present disclosure, a control panel for driving the device is installed at an upper portion of the front surface of the device body 101. The control panel is a panel for allowing an operator to control power, filter differential pressure, disk module state moisture, particles, and motor overload. In addition, a front case for protecting the moisture removal device is installed at a lower portion of the front surface. A plurality of gauges and a plurality of valves are formed on the side surface of the device body 101. The moisture removal device 100 using this nitrogen peeling and rotating disks can freely move due to the wheels installed at the lower end thereof so that the moisture removal device 100 can be easily moved from place to place.

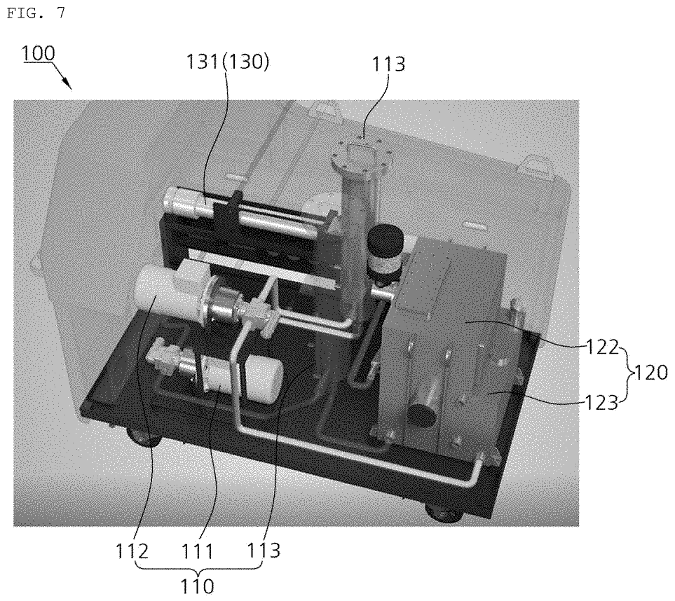

FIG. 6 is a view schematically showing the internal configuration of a moisture removal device using a rotating disk and nitrogen peeling, according to an embodiment of the present disclosure, and FIG. 7 is a view schematically showing a connection configuration between nitrogen peeling and internal components of a moisture removal device using rotating disks according to an embodiment of the present disclosure. As shown in FIGS. 6 and 7, the moisture removal device 100 using a rotating disk and nitrogen peeling, according to the present disclosure, is provided with an inlet pump 111 and an outlet pump 112 connected to circulate oil in the storage tank inside the device body 101. The circulation pump unit 110, in which a pair of particle filters 113 for removing particles of circulating oil is installed, is placed between the inlet pump 111 and the chamber 120, and between the outlet pump 112 and the chamber 120. In addition, the chamber 120 having a disk tank 122 in which a plurality of rotating disks 121 is installed is connected to the circulation pump unit 110, and a membrane unit 130 having a nitrogen generator 131 for generating nitrogen and a slit nozzle 132 is connected to supply nitrogen to the disk tank 122 of the chamber 120. Here, the slit nozzle 132 has a slit structure that allows the nitrogen supplied to the plurality of rotating disks 121 installed in the disk tank 122 to flow evenly and spread out.

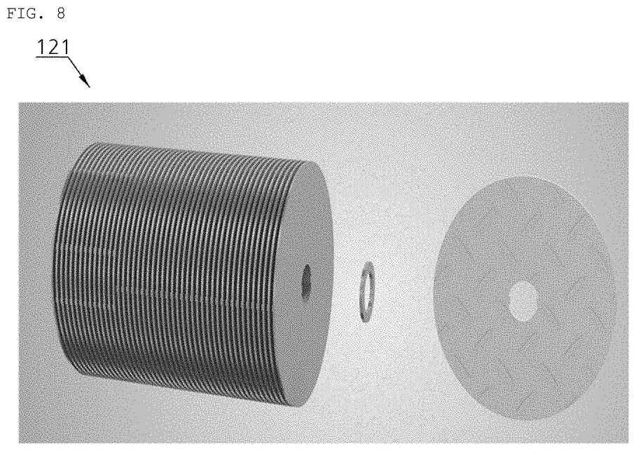

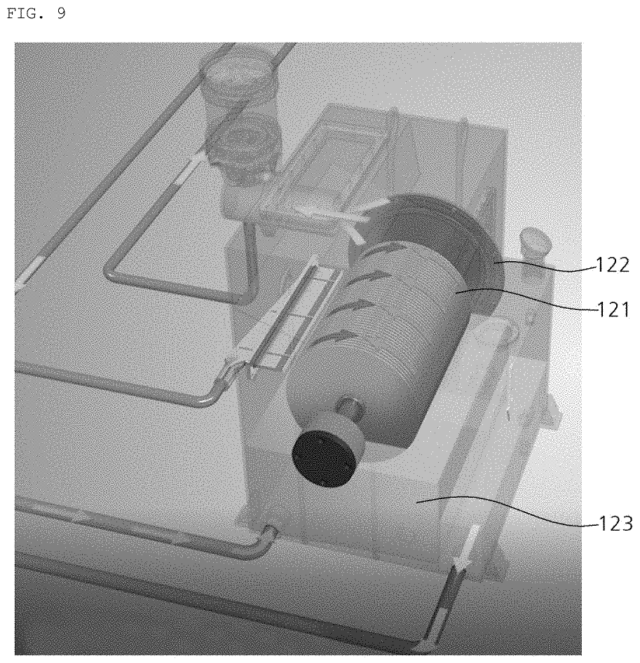

FIG. 8 is a view showing the configuration of a rotating disk of the moisture removal device using a rotating disk and nitrogen peeling according to an embodiment of the present disclosure. As shown in FIG. 8, the rotating disk 121 may be formed in a check plate structure in which a hole for fastening a driving shaft is formed at a center in a disk shape and a protrusion is formed in a radial disk of the hole. The plurality of rotating disks 121 may increase the contact area between air and oil by exposing the oil supplied to the disk tank 122 into the chamber headspace by rotation.

FIG. 9 is a view schematically showing an operation process of a moisture removal device using a rotating disk and nitrogen peeling according to an embodiment of the present disclosure. As shown in FIG. 9, the moisture removal device 100 functions to remove free moisture, emulsified moisture, and dissolved moisture from oil contaminated with moisture through dry nitrogen gas purging by using a continuously rotating disk 121. That is, inert and very dry nitrogen is generated in the nitrogen generator 131 and supplied to the disk tank 122 of the chamber 120, where lubricating oil and nitrogen are mixed. The rotating disk 121 installed in multiple stages inside the disk tank 122 of the chamber 120 rotates to maximize the contact surface area between dry nitrogen gas and the lubricating oil so that nitrogen supplied by nitrogen peeling holds moisture in the lubricating oil and discharges moisture to the outside to remove moisture in the lubricating oil.

As described above, the moisture removal device using a rotating disk and nitrogen peeling according to an embodiment of the present disclosure may include: a circulation pump unit for circulating the oil in the storage tank connected to the circulation pump through a valve on one side of the device body; a chamber for exposing the oil circulated through the circulation pump unit into the chamber headspace through the rotation of the plurality of rotating disks; and a membrane unit that supplies dry nitrogen gas to oil exposed in the chamber headspace through rotation of a plurality of rotating disks of the chamber. The moisture removal device may remove free moisture, emulsified moisture, and dissolved moisture from oil contaminated with moisture through dry nitrogen gas purging by using a continuously rotating disk. In addition, inert and very dry nitrogen is generated in the nitrogen generator and supplied to the disk tank of the chamber, where lubricating oil and nitrogen are mixed. The rotating disk installed in multiple stages inside the disk tank of the chamber rotates to maximize the contact surface area between dry nitrogen gas and the lubricating oil so that nitrogen supplied by nitrogen peeling holds moisture in the lubricating oil and discharges moisture to the outside to remove moisture in the lubricating oil. The moisture removal device may extend the replacement cycles of refined oil in which the degree of contamination of moisture is lowered beyond the simple employment of existing breather devices, thereby increasing the management efficiency of the oil purification and reducing the cost.

The present disclosure described above can be variously modified or applied by those skilled in the art to which the present disclosure belongs, and the scope of the technical idea according to the present disclosure should be defined by the following claims.

1. A moisture removal device using a rotating disk and nitrogen peeling, the device comprising:
a circulation pump unit (110) configured to circulate oil contained in a storage tank connected to the circulation pump to one side of a device body (101) via a valve;
a chamber (120) configured to cause the oil circulated by the circulation pump (110) to be exposed in a chamber headspace through rotation of a plurality of rotating disks (121); and
a membrane unit (130) configured to supply dry nitrogen gas to the oil exposed in the chamber headspace through rotation of the plurality of rotating disks (121) of the chamber (120).

2. The moisture removal device of claim 1, wherein the circulation pump unit (110) comprises:
an inlet pump (111) configured to supply the oil contained in the storage tank to the chamber (120); and
an outlet pump (112) configured to discharge the oil from which moisture is removed, from the chamber (120) to the storage tank.

3. The moisture removal device of claim 2, wherein the circulation pump unit (110) further includes a pair of particle filters (113) for removing particles contained in circulating oil and connected to and installed between the inlet pump (111) and the chamber (120), and between the outlet pump (112) and the chamber (120), respectively.

4. The moisture removal device of claim 1, wherein the chamber (120) comprises:
a disk tank (122) in which the plurality of rotating disks (121) for purifying oil circulated and supplied by the circulation pump unit (110) is installed;
a return tank (123) connected to a lower portion of the disk tank (122) and configured to circulate the oil from which moisture is removed from the disk tank (122) to the storage tank through the operation of the circulation pump (110); and
a driving unit (124) for rotationally driving the plurality of rotation disks (121) installed in the disk tank (122).

5. The moisture removal device of claim 4, wherein the driving unit (124) comprises:
a small geared motor configured to rotationally drive plurality of rotating disks (121) installed in the disk tank (122);
a power transmission unit connected by a combination of a speed reducer and a pulley; and
a drive shaft.

6. The moisture removal device of claim 4, wherein each of the plurality of rotating disks (121) has a check plate structure in which the disk has a central hole for fastening the drive shaft and protrusions on the radial surface thereof around the central hole.

7. The moisture removal device of claim 6, wherein the plurality of rotating disks (121) increases contact between air and the oil by supplying the oil to the chamber space through rotation thereof.

8. The moisture removal device of claim 4, wherein the membrane unit (130) comprises:
a nitrogen generator (131) configured to supply the dry nitrogen gas to the oil exposed in the chamber headspace through rotation of the plurality of rotating disks (121) of the chamber (120); and
a slit nozzle (132) through which the nitrogen uniformly flows and is supplied to plurality of rotating disks (121) installed in the disk chamber (122) where oil and nitrogen are mixed while supplying nitrogen generated by the nitrogen generator (131) to the disk chamber (122) of the chamber (120).
